(19) United States
(12) Patent Application Publication
(10) Pub. No.: US 2019/0095974 A1
(43) Pub. Date: Mar. 28, 2019

(54) Crypto-based access control system and methods for unified shopping experience

(71) Applicant: Sze Yuen Wong, Herndon, VA (US)

(72) Inventor: Sze Yuen Wong, Herndon, VA (US)

(21) Appl. No.: 15/713,993

(22) Filed: Sep. 25, 2017

(51) Int. Cl. G06Q 30/06; H04L 29/06; H04W 12/04

(52) U.S. Cl. CPC G06Q 30/0629; H04L 63/0428; H04W 4/021; H04W 12/04; H04L 63/06

(57) ABSTRACT

Systems and methods of a cipher-based intelligent locator system for locating a user within a space, the system includes providing a tag cloud having tags that communicate tag data with aggregators. The tag cloud and aggregators located within the space form a meshed network, the aggregators communicate data to a computer in communication with a cloud-based network. A user smart device with a mobile application wirelessly communicates with an internet system in communication with the cloud-based network. Receiving by the computer, information about the user smart device entering the meshed network by wireless tags positioned within the space. Information is obtained by the tags during a recognition process by wirelessly transmitting messages between the wireless tags to aggregators, and then wirelessly transmitting information from the aggregators to the computer, the computer communicates with the cloud-based network, the cloud-based network communicates with store administrator systems via jointly defined API interface.

### FIELD OF THE INVENTION

The present disclosure relates to cipher-based access control systems and methods.

### BACKGROUND OF THE INVENTION

Today's consumers lead busy lives and shopping takes time. Although in-store excursions can still be fun, in many ways shopping online or via a mobile device offers a better overall experience, whether from the couch after the kids are in bed, on a mobile phone during a quiet moment at lunch, or on the go. In many instances, customers have access to more information online than when talking to an in-store sales associate. Online reviews and price comparisons enable them to feel more confident in their buying decisions and free shipping offers are a fixture of the online marketplace, especially during the holidays. With consumer confidence growing in leaps and bounds, the decline in foot traffic signifies a shift in the way consumers shop and buy. Now consumers have heightened shopping expectations. In the age of the smartphone, consumers are in even greater control and want to not only shop Web inventory, but also use their phone to shop from and within stores.

This means retailers need to take the in-store experience to a different level. Omnichannel is the idea that every channel must work together to deliver a contextualized customer experience. The business case extends well beyond tactical initiatives to satisfy basic customer needs, such as increasing the lifetime value of customers, delivering faster inventory turns in-store and creating higher margins through reduced markdowns of stock stuck at the wrong store. Retailers must now focus on the experiences in their stores. Customers still enjoy exceptional brick-and-mortar events. For example, if the shopper wants to order an out-of-stock item from another store, locate complementary accessories or pay for their items while finishing up in the dressing room, retailers need strategies in-place to deliver on their expectations, and to focus on the broader benefits and understand the full customer engagement across all touch points in order to optimize the experience. A broader approach requires systems that can serve all interactions and nimbly adapt to new ones. The store need also to support and be connected with mobile applications distributed on different server devices, e.g., Google®, Apple® and/or Microsoft® servers for the mobile applications distributed on iOS® or Android® or Microsoft® devices. The applications are expected to provide different types of information to the user including up-to-date product related information, environment information within the space, etc. Other types of information could be coupons for promotional items, in-store location information of a product of interest, indicating to the user how to find the product of interest within the store by using the customer's smart device, and/or price history or price comparisons for the same product in different stores. User of a smart device may also requested smart device information related to product information, service information, other information or some combination thereof.

The store may be equipped with LCD pricing displays, e.g., for each individual product, which is also possible that the LCD pricing display can have the ability to receive payment information from smart devices and process payments directly while the consumer is located at the product location within the consumer store. A store often use independent Administrator systems or integrated Administrator systems in their overall IT infrastructure. An omnichannel needs to communicate with this Administrator system in order to provide the service, and it must be capable of saving power, and/or having no power in a disconnected state. The omnichannel system incorporates wireless communication from fixed radio emitting devices (or tags) to smart mobile applications downloaded onto smart devices, e.g., smartphones, tablets, computers, etc. The identity of the user needs to be encrypted for consumer protection.

There are systems employed for indoor positioning that are typically based on inertial navigation wherein these systems generally incorporate technologies such as Global Positioning System (GPS). With increasing technological advances and a consumer spending driven economy, businesses are looking to find ways to gather data to track consumer foot traffic within the retail space to increase sales other than using GPS systems. Given the recent slump in brick and mortar stores challenged by increasing online purchases, the ability to gather information about shoppers spending habits, traffic through the stores or even being able to reduce the number of store personnel is critical to the survival of some stores, such as specialty stores. Stores nowadays need to focus on the broader benefits and understand the full customer engagement across all touch points in order to optimize the experience. A broader approach requires systems that can serve all interactions and nimbly adapt to new ones. Salespeople need to be equipped with tablets or mobile technology that enable them to better serve customers. Shopper nowadays expects to be able to order an out-of-stock item from another store, locate complementary accessories or pay for their items while finishing up in the dressing room.

By The four basic principles of data security, data-at-rest should stay encrypted at all times, be portable to facilitate distribution across heterogeneous storage and protection mechanisms. Data-at-rest should be protected with baked-in security independent of its environment; eliminating any systems keys and/or lookup tables that may be misused as backdoors. If an employee needs access to the end-user's data in order to provide support, an explicit grant is required by the end-user themselves.

With the most recent data breach, even encrypted data was compromised due to some poor decisions of storing encryption keys within the same data center, thus the hackers got access to the keys once they got in. The crypto logic is still secure, but if the key is stolen, the crypto logic is irrelevant. If you follow the trend of all the massive data breaches, you can see the hackers are getting into bigger and bigger data repositories. From retail stores, to the government, now to the very place that stores credit information. The more concentrated the data, the more profitable a successful hack is. Conventional access control system architecture follows the “trust all employees within a given organization and allow access to most customer data.” With this mindset, any weak password could potentially expose the entire data repository.

In order to protect data in the event of data breach due to weak access control, the focus should not be about building bigger and thicker firewalls. As we have seen with recent events, any individual with enough incentive and skill can get through the thickest of firewalls and get inside any system. The focus should be on making it less profitable for hackers to break into any given system. Instead of building the bigger data repositories, we should instead build a distributed system. In simplest terms, once the hackers break-in, they can access ALL of the data.

### SUMMARY OF THE INVENTION

Consumers have previously downloaded a store specific mobile application running on their smart device. A radio based system capable of saving battery power for deployed, autonomous radio emitting devices disseminated within a space to form a meshed network. The meshed network of the fixed radio emitting devices create a geo-fence within the space, wherein the fixed radio emitting devices are capable of wirelessly communicating with neighboring fixed radio emitting devices. Upon the consumer opening the specific application for that space on the consumer's smart mobile device, the application can provide different types of information to the user. The application can provide different types of information to the user including up-to-date product related information, environment information within the space, etc. Other types of information could be coupons for promotional items, in-store location information of a product of interest, indicating to the user how to find the product of interest within the store by using the customer's smart device, and/or price history or price comparisons for the same product in different stores. User requested smart device information related to product information, service information, other information or some combination thereof that is requested by user directed to information located within the space is received, from the user of the user smart device.

A central computer can perform functions related to applications which need to be performed, such as sending product information via a product search engine back to the consumer on the consumer's smart mobile device, and/or performing real time product price comparisons in a specified geographical area and in a product category when prompted by the user. The central computer can be completely independent of the store administrator systems or able to communicate with it via a jointly defined interface or an API. The central computer can be connected with a web based price finder engine which finds all competitor's prices for specific products in real time within the consumer's approximate location. The central computer can also be connected with mobile applications distributed on different server devices, e.g., Google®, Apple® and/or Microsoft® servers for the mobile applications distributed on iOS® or Android® or Microsoft® devices. The applications running on iOS® or Android® or Windows® devices can be downloadable and can contain specific applications along with performing specific functions directed by the central computer.

The store may be equipped with LCD pricing displays, e.g., for each individual product, which can communicate via a bidirectional wireless radio interface with a centralized computer system. It is also possible that the LCD pricing display can have the ability to receive payment information from smart devices and process payments directly via the bi-directional wireless interface while the consumer is located at the product location within the consumer store.

The radio based system incorporates communication from the fixed radio emitting devices (or tags) (e.g., to aggregators and through the central computer, the cloud-based network) and to smart mobile applications downloaded onto smart devices, e.g., smartphones, tablets, computers, etc. The identity of the user is locally encrypted by the application and also stored (encrypted) on the iForm Cloud. Upon entering the area defined by the Tag Cloud, the user breaks the geo-fence established by the Tag Cloud. As soon as the geo-fence is broken by the smart device, the iForm system sends a notification message to the administrator system informing it that User X arrived on the premises or within the space. TAG1 (212A) is sensed by the user's smart device and a message is generated, via servers to the iForm Cloud with the contextual information (user ID, TAG1(212A) identifier & time stamp). The iForm Cloud ID matches the user profile it stores in its database and sends event based contextual information to the Scheduling system, which can inform the personnel of the location of the patient/customer.

A KeyWrap Record and the four underlying principles of cipher-based data security to its architecture. In a KeyWrap Record, a Data component is coupled with its Decryption Key components to form a composite data structure. Both components stay encrypted at rest. A Decryption Key component is protected by a separate RecordSet Key. Data component is protected from improper access to a KeyWrap Record without having obtained access to its corresponding RecordSet Key. Implemented as a JSON structure, a KeyWrap Record is highly portable, allowing straightforward distribution across heterogeneous storage and protection mechanisms. A nested-key design provides inherent cipher-based protection to both its data component and its decryption key component when at rest, independent of and in addition to any access control mechanisms of the environment.

As data flows arrive at the central computer, data are filtered and transformed to enter into KeyWrap Records grouped into one or more RecordSets. Long running requests, such as The Excel Flattening feature, will access the encrypted data from the RecordSet by using a Dataflow Automation API, and be able to decrypt those Data by means of an Access Token. In one embodiment, the Excel Service insert data into an excel file one record at a time via an Excel library. In another embodiment, the Excel Service insert all records to the Excel file all at once. Data are not being passed through the Excel service API. Instead, the Dataflow Id, RecordSet Id are being passed.

A cipher-based intelligent locator system for locating a user within a space, the system including providing a tag cloud having multiple tags that communicate tag data with aggregators, wherein the tag cloud and aggregators are located within the space and form a meshed network, the aggregators communicate data to a central computer that is in communication with a cloud-based network; providing a user smart device capable of downloading a mobile application wirelessly and wirelessly communicating with an internet system that is in communication with the cloud-based network; receiving by the central computer, information about the user smart device entering the meshed network by wireless tags positioned within the space; wherein the information is obtained by the wireless tags during a recognition process that comprises wirelessly transmitting messages between the wireless tags to aggregators, then wirelessly transmitting the information from the aggregators to the central computer, wherein the central computer communicates with the cloud-based network, wherein the wireless tags transition from a sleep state to an active state; determining locations of the user smart device in the space in response to the information and to calibration information indicative of an actual or estimated location of the user smart device within the space; receiving, from cloud-base network, user smart device information related to a location of the user smart device in relation to wireless tags within the space, for the user to open the mobile application on the user smart device of the user; receiving, from the user of the user smart device, user smart device information related to a location of the user smart device in relation to a subset of the wireless tags; determining a location of the user smart device within the space in response to the user smart device location information and to locations of the wireless tags of the sub-set of wireless tags in the space, wherein each tag of the tags not within an approximate range of the user smart device within the space, receives wireless transmissions from other tags to transition from the active state to the sleep state.

In an embodiment, a method comprises creating, by a plurality of radio emitting devices each comprising a processor and transceiver, a geo-fence within a space, each radio emitting device capable of communicating with neighboring radio emitting devices in the plurality and capable of communicating with aggregators in communication with a central server computer over a network; and determining, by a subset of the plurality of radio emitting devices, a location of a user computing device executing a user application for the space when the user computing device is moved past the geo-fence and into the space, the determined location relative to the subset of the radio emitting devices, each radio emitting device in the subset transitioning from a sleep state to an active state when the user computing device moves within a predetermined distance from the subset of the radio emitting devices.

In an embodiment, a radio emitting device comprises a processor; a transceiver for communicating with other radio emitting devices and for communicating with an aggregator in communication with a central server computer over a network; and a storage medium for tangibly storing thereon program logic for execution by the processor, the program logic comprising radio emitting device communicating logic executed by the processor for communicating with a plurality of radio emitting devices to create a geo-fence within a space and for facilitating determination of a location of a user computing device by the radio emitting device and a subset of the plurality of radio emitting devices, the user computing device executing a user application for the space, the facilitating determination of the location occurring when the user computing device is moved past the geo-fence and into the space, the determined location relative to the radio emitting device, the radio emitting device transitioning from a sleep state to an active state when the user computing device moves within a predetermined distance from the subset of the radio emitting devices.

In an embodiment, a non-transitory computer readable storage medium tangibly storing thereon computer instructions for execution by a processor of a radio emitting device, the computer instructions comprising communicating with a plurality of radio emitting devices to create a geo-fence within a space and for facilitating determination of a location of a user computing device by the radio emitting device and a subset of the plurality of radio emitting devices, the user computing device executing a user application for the space, the facilitating determination of the location occurring when the user computing device is moved past the geo-fence and into the space, the determined location relative to the radio emitting device, the radio emitting device transitioning from a sleep state to an active state when the user computing device moves within a predetermined distance from the subset of the radio emitting devices.

### BRIEF DESCRIPTION OF THE DRAWINGS

FIG. 1A illustrates a KeyWrap Record diagram.

FIG. 1B illustrate tags and aggregators of the system structure that can communicate within the tag cloud and the central computer, according to an embodiment of the present disclosure.

FIG. 1C illustrates a smart device application downloaded on a smart device of the system structure located within a geo-fence within the tag cloud, according to an embodiment of the present disclosure.

FIG. 2A illustrates an embodiment of a radio based system capable of saving power for deployed, autonomous radio emitting devices disseminated within a space to form a geo-fence or meshed network, according to an embodiment of the present disclosure.

FIG. 2B illustrates an embodiment of the radio based system, after physically placing the tags and aggregators within the space to form the meshed network, where power is later provided to the tags and aggregators so the geo-fence or meshed network can be set up, according to an embodiment of the present disclosure.

FIG. 3A illustrates a system that connects to a consumer related system that can direct consumers to consumer objects of interests, provide the consumer with real-time pricing information specific to the consumer objects of interests as well as initialize payment methods for the consumer to purchase the consumer objects of interests at the location of the objects of interests in the space, according to an embodiment of the present disclosure.

FIG. 3B is a flow diagram illustrating the steps of FIG. 3A. It describes that steps of directing consumers to consumer objects of interests, providing consumers with real-time pricing information specific to the consumer objects of interests as well as the steps of providing initialized payment methods for the consumer to purchase the consumer objects of interests at the location of the objects of interests in the space, according to an embodiment of the present disclosure.

FIG. 3C illustrates the four underlying principles of cipher-based data security.

### DETAILED DESCRIPTION OF THE INVENTION

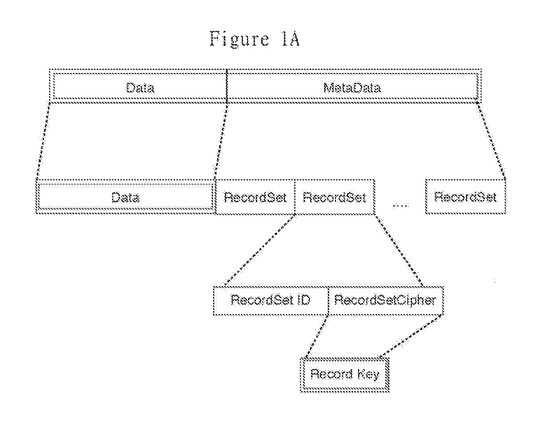

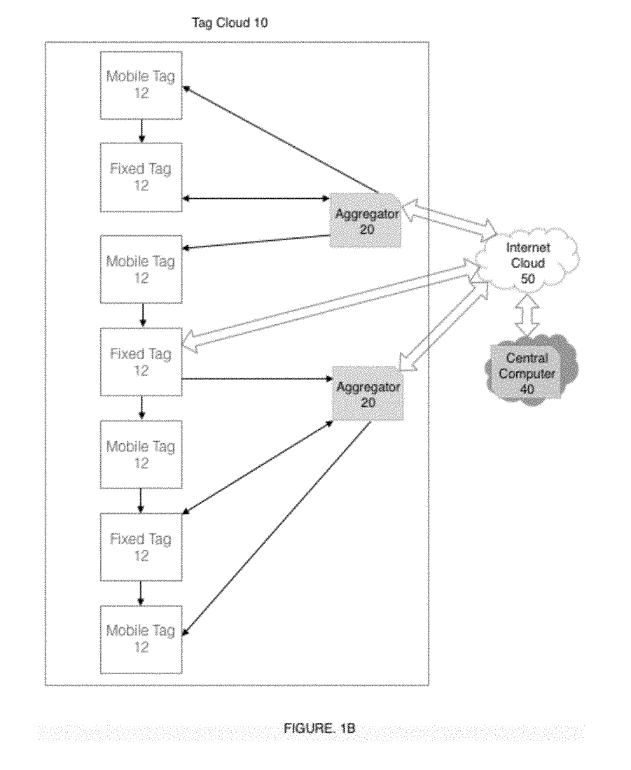

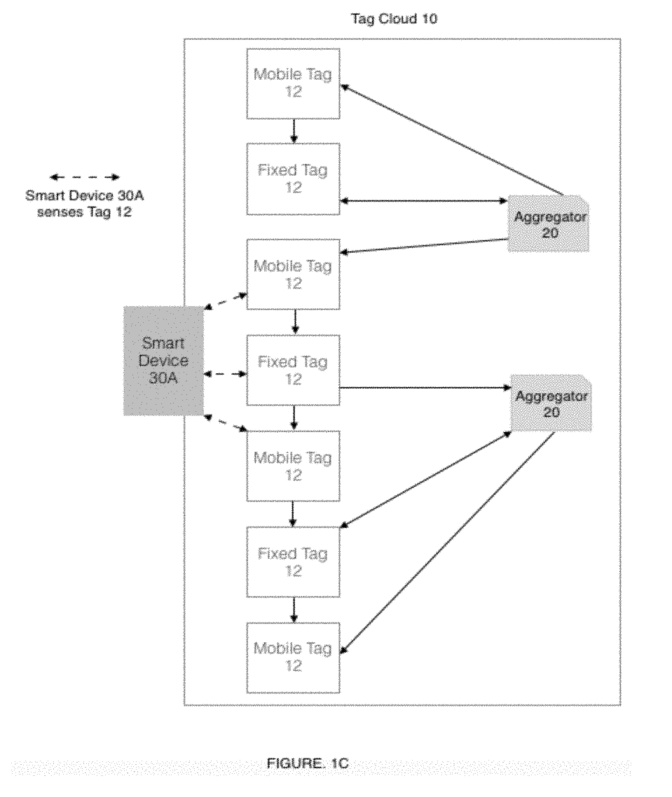

FIG. 1A illustrates a KeyWrap Record and the four underlying principles of cipher-based data security to its architecture. In a KeyWrap Record, a Data component is coupled with its Decryption Key components to form a composite data structure, representing a most atomic data representation unit in the architecture. Both components stay encrypted at rest. A Decryption Key component is protected by a separate RecordSet Key. Thus, a Data component is protected from improper access to a KeyWrap Record without having obtained access to its corresponding RecordSet Key. Implemented as a JSON structure, a KeyWrap Record is highly portable, allowing straightforward distribution across heterogeneous storage and protection mechanisms. A nested-key design provides inherent cipher-based protection to both its data component and its decryption key component when at rest, and it offers protection in a way that is independent of and in addition to any access control mechanisms happen to be offered by a destined storage system, thereby eliminating any risk of having dependencies on any weak access control protection external to the KeyWrap Record. System keys and/or lookup tables are eliminated by design, thereby enhancing protection from weak username and passwords, as well as maintaining trust and integrity if and when distributed across access control systems disparate in quality and character.

Referring to FIG. 1B and FIG. 1C, the central computer 40 according to the present disclosure can perform real time product price comparisons in a specified geographical area and in a product category when prompted by the user. For example, upon a search initiated by a consumer on the consumer's smart mobile device, the central computer 40 can relay the consumer's request to a store where the consumer is currently located. Some features the central computer 40 may be able to perform can include, by non-limiting example: a) Supplying product related information, environment information within the space, etc.; b) Location of the product nearby being offered for sale near the consumer's location outside of the space; c) Provide a comparison of the best prices available from the price finder search engine and sends the identified new best price, if necessary, back to the user's smart device's LCD dynamically. The LCD can now display the new best price, the retailer can then advertise to all of its customers that they can provide “The Best Price Guarantee”; d) The central computer will send the consumer smart mobile device the location of the product searched; e) The store application on the consumer's smart mobile device can provide a way to finding products within the space, via an indoor turn by turn navigation-like engine showing the consumer the specific requested area, aisle, shelf where the product is located; and f) If the smart mobile device is equipped with a payment method accepted by the store, the consumer may pay directly at their current location within the space, i.e. the shelf where the product is located, so as to save the consumer from wasting additional time at check-out lines.

FIG. 1B illustrate tags 12 and aggregators 20 of the system structure 100 that can communicate within a tag cloud 10 and the central computer 40. Consumers have previously downloaded a store specific mobile application running on their smart device. Some aspects of the tags 12 and aggregators 20 include the ability to “know” when a smart mobile application is active and to “know” the relative location of the interacting device or smart device within a geo-fence or meshed network in the space. As soon as the geo-fence is broken by the smart device, the iForm system sends a notification message to the store administrator system informing it that User X arrived on the premises or within the space. A user must be signed into the application with a unique ID/password combination. The identity of the user is locally encrypted by the application and also stored (encrypted) on the iForm Cloud. Upon entering the area defined by the Tag Cloud, the user breaks the geo-fence established by the Tag Cloud. TAG1 (212A) is sensed by the user's smart device and a message is generated, via servers to the iForm Cloud with the contextual information (user ID, TAG1(212A) identifier & time stamp). The iForm Cloud ID matches the user profile it stores in its database and sends event based contextual information to the store administrator system, which can inform the personnel of the location of the customer. The iForm Cloud can be completely independent of the store administrator systems or able to communicate with it via a jointly defined interface or an API. The consumer can decide to identify itself by providing a login information via the application or decide to be anonymous. If the login is provided, the store can push personalized, location based messages to the consumer. The store administrator system can check the identity of User X and match the records stored in its own database. If the records match, store administrator system checks in User X for his/her visit. If administrator system contains the personal records of User X and if User X is allowed to preview its personal information via the application running on the mobile device, then User X can check that all personal information is correct and commit any changes made via the application running on the mobile device.

There are different types of aggregators 20 that may be incorporated in the methods and systems of the present disclosure. For example, there can be aggregators 20 including stationary aggregators, mobile aggregators or aggregators that can communicate with hardware through software. Aggregators 20 can have one or more of the following functions in communicating with tags 12 within the tag cloud 10 and the central computer 40. For example, aggregators 20 may: (a) read and store the radio power level of each of the tags 12 it connects to; (b) dynamically instruct the tags 12 to Transmit (Tx) power; (c) dynamically instruct the tags 12 of the frequency of their signal; and (d) push new FW (firmware) version(s) to the tags 12. It is noted that there can be at least 2 ways for implementation: (1) first, where the aggregators can be “dumb” and only transmit data and commands back and forth between tags and central computer. Further, this is the centralized architecture which can require more signaling between all entities, so more battery power is used; (2) second, the other way can be push intelligence into the aggregators in order for them to take some decisions locally, without the overhead messaging required with the central computer (this is the distributed architecture).

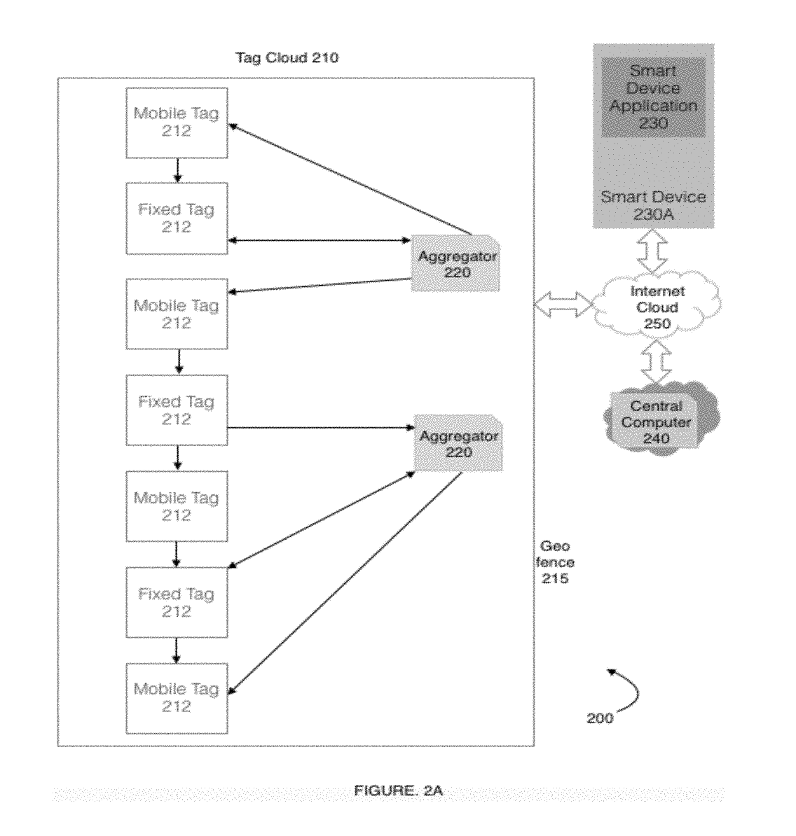

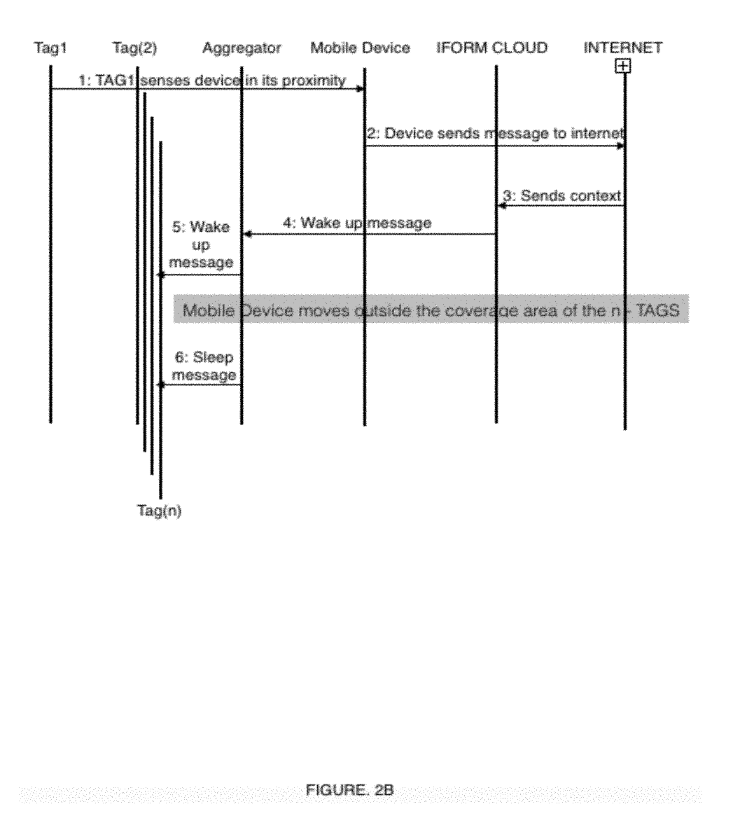

FIG. 2A illustrates an embodiment of a radio based system 200 capable of saving battery power for deployed, autonomous radio emitting devices (tag cloud 210 including tags 212, aggregators 220 and at least one TAG1 212A) disseminated within a space 215 to form a geo-fence or meshed network 225. The meshed network includes fixed tags 212 and aggregators 220 positioned strategically in the space 215, wherein the tags 212 and aggregators 220 wirelessly communicate with neighboring fixed tags 212 and aggregators 220 to form a meshed network 225. The fixed tags 212 communicate with aggregators 220 to connect to a central computer 240 that is in communication with a cloud-based network 250 via the internet. The radio based system 200 incorporates communication data gathered from the fixed tags 212 via aggregators 220 through the central computer 240, the cloud-based network 250 to smart mobile applications 230 downloaded onto smart devices 230A.

Referring to FIG. 2B, after physically placing the tags 212 and aggregators 220 within the space 215 to form the meshed network 225, power can be provided to the tags 212 and aggregators 220 so the geo-fence or meshed network 225 can be set up. For example, after tags 212 and aggregators 220 have been placed in a fixed position and power is applied, each tag 212 and aggregator 220 starts emitting its beacon signal with the maximum transmitting power (i.e. active state). The neighbor beacon listens to all of the beacon signals coming from all of the deployed tags 212 and aggregators 220 and sends the values it recorded to the gateway, i.e. TAG1 212A.

During this initial startup process, the system 200 begins building a map or the geo-fence or meshed network 225. For example, the aggregators 220 “know” the location of each tag 212, i.e. each tag 212 has an ID which it uses in its broadcast. Once the aggregators 220 record the RF powers from each tag 212 regarding the values it recorded from all other tags 212, the Central Computer 240 can begin to: (1) build a map with a neighbor list for each one of the tags 212 and their respective value, for instance, the Central Computer 240 can decide to keep, e.g., four (4) neighbors for each tag 212 with an associated signal strength; (2) the Central Computer 240 can use a learning algorithm to compute the mean and standard deviation for 95% confidence level for each neighbor tag 212 in the list. For example, depending of the mean and standard deviation values, the Central Computer 240 will assign a relative threshold level for, in a one to one relationship, in order to increase maximum likelihood for a location of a tag 212 to be computed with a high degree of certainty.

In the initial operation of the system 200, the TAG1 212A will sense that a smart device 230A broke the geo-fence it created earlier (i.e. the smart device 230A needs to be approximate the meshed network). The mobile application 230 running on the smart device 230A receives the TAG1 212A signal and sends a message over cellular network to the servers communicating with the Central Computer 240, e.g., iForm Cloud, informing the Central Computer 240 that it is running a certain mobile application. The servers forward the message to the Central Computer 240, e.g., iForm Cloud, with the context received from the application 230 running on the Smart Mobile Device 230A. The Central Computer 240, e.g., iForm Cloud, sends a wakeup message to a tag 212 or aggregator 220 where TAG1 212A is registered to belong. The tag 212 or aggregator 220 sends a wakeup message to all neighboring TAGs 212 approximate the TAG1 212A to place them in a wake up state. After the smart mobile device 230A passes the area covered by the n TAGS, the aggregator (AGGR) (or neighbor tags) send a SLEEP message to all n TAGS to resume sleep mode.

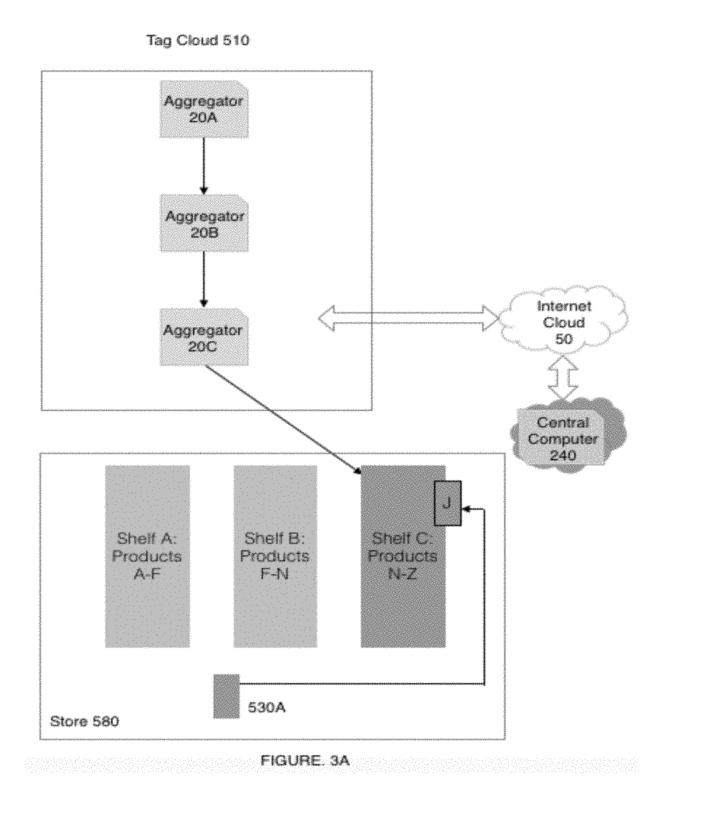

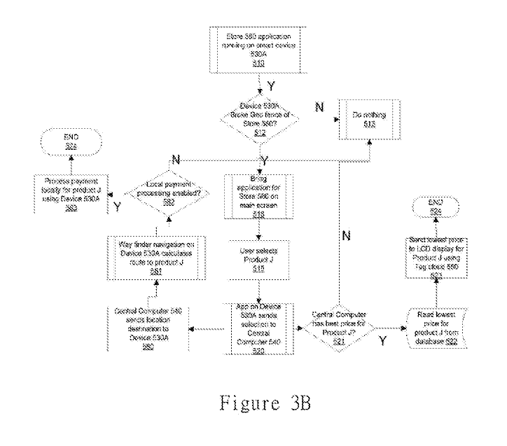

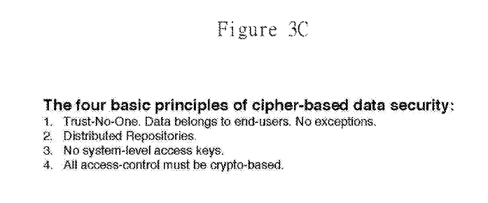

FIG. 3A illustrates a system that can be connected to a consumer related system and can direct consumers to consumer objects of interests, provide the consumer with real-time pricing information specific to the consumer objects of interests as well as initialize payment methods for the consumer to purchase the consumer objects of interests at the location of the objects of interests in the space. For example, the consumer store (or warehouse) can be equipped with sensors allowing geo-fencing sensing and triggering for a smart mobile device entering the consumer store. It is possible the store can be equipped with sensors allowing a smart device to be provided with an indoor directional finding, i.e. navigation method. Further, the store may be equipped with LCD pricing displays, e.g., for each individual product, which can communicate via a bidirectional wireless radio interface with a centralized computer system. The smart mobile device can be running the store specific application in the background, while the store centralized computer is connected with a web based price finder engine which finds all competitor's prices for specific products in real time within the consumer's approximate location. It is also possible that the LCD pricing display can have the ability to receive payment information from smart devices and process payments directly via the bi-directional wireless interface while the consumer is located at the product location within the consumer store.

FIG. 3B is a flow diagram illustrating the steps for directing consumers to consumer objects of interests (e.g., products, etc.), provide the consumer with pricing information specific to the consumer objects of interests as well as initial payment methods for the consumer to purchase the consumer objects of interests within a consumer space, e.g., consumer store or warehouse.

Step 510 is a prerequisite where the consumer's smart mobile device has the store specific application installed and running in the background. Step 512 begins when a consumer enters the store; its smart mobile device breaks the geo-fence created by the fixed sensors disseminated around the store facility. At step 516, the interaction between the sensor and the smart mobile device can trigger the store specific application to come up or to send a notification to the user to open the store specific application. At step 518, the application contains (either locally on the smart device or remotely on the central computer) the product categories and individual products for each category. The user, via a drop down menu or via a voice recognition engine specific to the application, selects the product category and then the exact product it intends to purchase (or review).

FIG. 1A illustrates a KeyWrap Record and the four underlying principles of cipher-based data security to its architecture. In a KeyWrap Record, a Data component is coupled with its Decryption Key components to form a composite data structure, representing a most atomic data representation unit in the architecture. Both components stay encrypted at rest. A Decryption Key component is protected by a separate RecordSet Key. Thus, a Data component is protected from improper access to a KeyWrap Record without having obtained access to its corresponding RecordSet Key. Implemented as a JSON structure, a KeyWrap Record is highly portable, allowing straightforward distribution across heterogeneous storage and protection mechanisms. A nested-key design provides inherent cipher-based protection to both its data component and its decryption key component when at rest, and it offers protection in a way that is independent of and in addition to any access control mechanisms happen to be offered by a destined storage system, thereby eliminating any risk of having dependencies on any weak access control protection external to the KeyWrap Record. System keys and/or lookup tables are eliminated by design, thereby enhancing protection from weak username and passwords, as well as maintaining trust and integrity if and when distributed across access control systems disparate in quality and character.

As data flows arrive at the central computer, data are filtered and transformed to enter into KeyWrap Records grouped into one or more RecordSets. An iForm aggregate API is called to retrieve Page, Element, Option List, and Options information from the mobile application. The API can be called one time during setup or runtime (everytime the data enter the RecordSet) to transform the data accordingly based on the option selected above. Long running requests, such as The Excel Flattening feature, will access the encrypted data from the RecordSet by using a Dataflow Automation API, and be able to decrypt those Data by means of an Access Token. Dataflow Automation is an entirely separate service that will store Flattened/Transformed data into RecordSet. In one embodiment, the Excel Service became one of the Post Actions for Dataflow Automation to insert data into an excel file one record at a time via an Excel library. In another embodiment, the Excel Service insert all records to the Excel file all at once. Data are not being passed through the Excel service API. Instead, the Dataflow Id, RecordSet Id are being passed.

Multi-record Subform need to be in its own tab (in Excel). A subform structure having one or more page records can be shown in the same tab or separate tabs, where options to handle subform structure will be shown in a field on a admin UI. A multi-record subform will be implemented as a sub-JSON-object for storage in one or more RecordSets.

In an embodiment, the central server carries out real time product price comparisons in a specified geographical area and in a product category when prompted by the user. Dynamic supply of product related information and environment information within the space, including price, product specifications, location of the product nearby being offered for sale near the consumer's location outside of the space, etc. Other types of information could be coupons for promotional items, in-store location information of a product of interest, indicating to the user how to find the product of interest within the store by using the customer's smart device, and/or price history or price comparisons for the same product in different stores. The smart mobile device can be running the store specific application in the background, while the store centralized computer is connected with a web based price finder engine which finds all competitor's prices for specific products in real time within the consumer's approximate location. The central computer 40 will send the consumer smart mobile device the location of the product searched, and provide a comparison of the best prices available from the price finder search engine and sends the identified new best price, if necessary, back to the user's smart device's LCD.

The mobile application 230 running on the smart device 230A receives the TAG1 212A signal and sends a message over cellular network to the servers communicating with the Central Computer 240, e.g., iForm Cloud, informing the Central Computer 240 that it is running a certain mobile application.

High performance message infrastructure is used for meeting an exponential growth in data. As a request coming in, the request is added to the RabbitMQ to ensure the order of subtasks. When the consumer consumes a message from the the RabbitMQ, it will create a child process. A child process will be used to retrieve data from Dataflow Automation API and write them into an excel file.

Incorporated into embodiments of the present disclosure, the following elements may be included; a tag cloud having tags, aggregators positioned within an approximate the tag cloud, a central computer, a cloud-based network (cloud), a smart device application and a smart device.

For purposes of the present disclosure, a tag can include a wireless transceiver, processor and it can include its own power supply. For example, tags generally can have a Tx/Rx radio front end and the ability to “listen” to its neighbor beacons in order to adjust its power based on surrounding radio activity. A group of tags within a space forming a meshed network may be considered a tag cloud. It is noted that tags can also adjust their Tx power and the transmission interval when instructed through the aggregators by the cloud computer.

By non-limiting example, some types of features of tags may include: (1) Bluetooth tags (sTAG) having HW/SW elements which are fixed or mobile; (2) Dual-stack TAG (dsTAG), having a dual BT (Bluetooth) stack able to simultaneously receive on one and transmit on the other; (3) tags communicating with aggregators incorporating multi functions; (4) tags communicating by itself or through other devices with a central computer and (5) tags communicating through other devices (i.e. aggregators, central computer, cloud network) to communicate with an application running on iOS or Android or Windows devices. However, other elements are contemplated and may be included which is dependent upon the specific desired configuration.

For purposes of the present disclosure, a meshed network can generally be considered as a type of network topology in which a device, tag or node can transmit its own data as well as serves as a relay for other tags or nodes located near it. The tags or nodes can be wireless using routers to provide for an efficient data transfer path for effective communication. It is noted that the nodes (or aggregators in the meshed network) can also be linked to the internet and the cloud computer via a wireless or Ethernet network.

A cipher-based intelligent locator system for locating a user within a space, the system comprises providing a tag cloud having multiple tags that communicate tag data with aggregators, wherein the tag cloud and aggregators are located within the space and form a meshed network, the aggregators communicate data to a central computer that is in communication with a cloud-based network. The system provides a user smart device capable of downloading a mobile application wirelessly and wirelessly communicating with an internet system that is in communication with the cloud-based network. The central computer receives information about the user smart device entering the meshed network by wireless tags positioned within the space. The information is obtained by the wireless tags during a recognition process that comprises wirelessly transmitting messages between the wireless tags to aggregators, then wirelessly transmitting the information from the aggregators to the central computer, wherein the central computer communicates with the cloud-based network, wherein the wireless tags transition from a sleep state to an active state. Locations of the user smart device in the space are determined in response to the information, and are used to calibrate information indicative of an actual or estimated location of the user smart device within the space.

In an embodiment, a radio emitting device comprises a processor; a transceiver for communicating with other radio emitting devices and for communicating with an aggregator in communication with a central server computer over a network; and a storage medium for tangibly storing thereon program logic for execution by the processor, the program logic comprising radio emitting device communicating logic executed by the processor for communicating with a plurality of radio emitting devices to create a geo-fence within a space and for facilitating determination of a location of a user computing device by the radio emitting device and a subset of the plurality of radio emitting devices, the user computing device executing a user application for the space, the facilitating determination of the location occurring when the user computing device is moved past the geo-fence and into the space, the determined location relative to the radio emitting device, the radio emitting device transitioning from a sleep state to an active state when the user computing device moves within a predetermined distance from the subset of the radio emitting devices.

In an embodiment, a non-transitory computer readable storage medium tangibly storing thereon computer instructions for execution by a processor of a radio emitting device, the computer instructions comprising communicating with a plurality of radio emitting devices to create a geo-fence within a space and for facilitating determination of a location of a user computing device by the radio emitting device and a subset of the plurality of radio emitting devices, the user computing device executing a user application for the space, the facilitating determination of the location occurring when the user computing device is moved past the geo-fence and into the space, the determined location relative to the radio emitting device, the radio emitting device transitioning from a sleep state to an active state when the user computing device moves within a predetermined distance from the subset of the radio emitting devices.

1. A method comprising:
creating, by a plurality of radio emitting devices each comprising a processor and transceiver, a geo-fence within a space, each radio emitting device capable of communicating with neighboring radio emitting devices in the plurality and capable of communicating with aggregators in communication with a central server computer over a network;
determining, by a subset of the plurality of radio emitting devices, a location of a user computing device executing a user application for the space when the user computing device is moved past the geo-fence and into the space, the determined location relative to the subset of the radio emitting devices, each radio emitting device in the subset transitioning from a sleep state to an active state when the user computing device moves within a predetermined distance from the subset of the radio emitting devices; and
executing, by the central server computer upon a search initiated by a consumer on the user computing device, geographical area specific logic, the geographical area specific logic comprising:
i) relaying the consumer's request to a store at the determined location to perform real time product price comparisons,
ii) facilitating determination of the consumer's identity based on a composite data structure having a data component that is locally encrypted by the user application and stored on the central server computer, and
iii) sending event based contextual information including the determined consumer's identity to an integrated store Administrator system, the store Administrator system informs store personnel of the determined location.

2. The method of claim 1, further comprising providing a tag cloud comprising the plurality of radio emitting devices.

3. A radio emitting device comprising:
a processor;
a transceiver for communicating with other radio emitting devices and for communicating with an aggregator in communication with a central server computer over a network; and
a storage medium for tangibly storing thereon program logic for execution by the processor, the program logic comprising:
radio emitting device communicating logic executed by the processor for communicating with a plurality of radio emitting devices to create a geo-fence within a space and for facilitating determination of a location of a user computing device by the radio emitting device and a subset of the plurality of radio emitting devices,
the user computing device executing a user application for the facilitating determination of the location occurring when the user computing device is moved past the geo-fence and into the space, the determined location relative to the radio emitting device, the radio emitting device transitioning from a sleep state to an active state when the user computing device moves within a predetermined distance from the subset of the radio emitting devices,
the central server computer, upon a search initiated by a consumer on the user computing device, executing geographical area specific logic, the geographical area specific logic comprising:
i) relaying the consumer's request to a store at the determined location to perform real time product price comparisons,
ii) facilitating determination of the consumer's identity based on a composite data structure having a data component that is locally encrypted by the user application and stored on the central server computer, and
iii) sending event based contextual information including the determined consumer's identity to an integrated scheduling system, the scheduling system informs store personnel of the determined location.

4. The radio emitting device of claim 3, wherein the user application provides product information about a product to the user computing device.

5. The radio emitting device of claim 4, wherein the product information is provided when the user computing device moves within a predetermined distance from the product.

6. The radio emitting device of claim 4, wherein the product information comprises navigation information to the product.

7. The radio emitting device of claim 6, wherein the user application provides environment information within the space to the user computing device.

8. The radio emitting device of claim 3, wherein the user application automatically checks a user of the user computing device into the space when the user computing device moves past the geo-fence.

9. A non-transitory computer readable storage medium tangibly storing thereon computer instructions for execution by a processor of a radio emitting device, the computer instructions comprising:
communicating with a plurality of radio emitting devices to create a geo-fence within a space and for facilitating determination of a location of a user computing device by the radio emitting device and a subset of the plurality of radio emitting devices, the user computing device executing a user application for the space, the facilitating determination of the location occurring when the user computing device is moved past the geo-fence and into the space, the determined location relative to the radio emitting device, the radio emitting device transitioning from a sleep state to an active state when the user computing device moves within a predetermined distance from the subset of the radio emitting devices.
the central server computer executing geographical area specific logic to relay a consumer's search request to a store at the determined location to perform real time product price comparisons, facilitate determination of the consumer's identity based on a composite data structure having a data component that is locally encrypted by the user application and stored on the central server computer, and to send event based contextual information including the determined consumer's identity to an integrated store Administrator system, wherein the store Administrator system informs store personnel of the determined location.

10. The medium of claim 9, wherein the user application automatically checks a user of the user computing device into the space when the user computing device moves past the geo-fence.
